(19) United States
(12) Patent Application Publication
(10) Pub. No.: US 2002/0170039 A1
(43) Pub. Date: Nov. 14, 2002

(54) System for operating system and platform independent digital stream handling and method thereof

(76) Inventor: Branko D. Kovacevic, Willowdale (CA)

Correspondence Address: SIMON, GALASSO & FRANTZ PLC, P.O. BOX 26503, AUSTIN, TX, 78755-0503, US

(21) Appl. No.: 09/791,048

(22) Filed: Feb. 22, 2001

(51) Int. Cl. G06F 9/45

(52) U.S. Cl. 717/138

(57) ABSTRACT

A system and methods are shown for providing access of specific hardware components and an operating system through a collection of highly transportable drivers. Commands generated by an application are received through the collection of highly transportable drivers. The drivers represent the generated commands using sets of function calls. The function call's access functions are available in sets of platform dependent drivers. The platform dependent drivers provide access to specific system components using the functions, allowing the generated commands to be used for a variety of hardware and operating system types. The hardware and operating system can be altered without altering or replacing the highly transportable drivers.

### FIELD OF THE DISCLOSURE

The present invention relates generally to information handling systems and more particularly to drivers within an information handling systems.

### BACKGROUND

The international organization for standards (ISO) moving pictures experts group (MPEG group), approved an audio video digital compression standard, based on packetized stream data, known as MPEG-2 in an effort to provide a versatile compression standard capable of being utilized for a wide variety of data. The MPEG-2 standard provides explanations needed to implement an MPEG-2 decoder through the use of syntax and semantics of a coded bit stream. MPEG-2 is an open standard which continues to evolve and be applied to a variety of applications ranging from video conferencing to high definition television.

Digital content is being used to represent and deliver entertainment programs to consumers. The digital content is broadcast through satellite broadcast, as in digital satellite systems, and through high-density television (HDTV) systems. Consumers make use of MPEG-2 decoders to process the video content for viewing on a television screen or other display. Information handling systems are generally used for decoder processing of the broadcast content.

Traditional methods for handling digital broadcast reception and playback on a host information handling system are hard coupled to the capabilities of a host processor and operating system within the information handling system. Accordingly, driver development becomes either hardware or operating system specific. As new hardware, operating systems, or hardware platforms become available, decoding systems are updated. Device drivers use direct operating system services for event creation and management, thread handling, and notifications. Since device drivers have generally become operating system specific in implementation, they are difficult to incorporate into decoders with a new operating system.

In general, decoder migration to a system with new hardware, operating system, or software platform is troublesome. Emulators have been developed to improve software portability. However, emulators are generally specific to an operating system environment in which they are run. Prior art solutions resulted in poor software code portability and operating system portability with unpredictable latencies and poor interrupt handling. A lack of code portability or code migration results in long software development cycles, long time-to-market time, and slow response when adding new features. Therefore, a system and method of decoding multimedia that allows for more flexibility and portability would be advantageous.

### BRIEF DESCRIPTION OF THE DRAWINGS

Specific embodiments of the present invention are shown and described in the drawings presented herein. Various objects, advantages, features and characteristics of the present invention, as well as methods, operation and functions of related elements of structure, and the combination of parts and economies of manufacture, will become apparent upon consideration of the following description and claims with reference to the accompanying drawings, all of which form apart of this specification, and wherein:

FIG. 1 is a block diagram illustrating a system for processing multimedia data through a series of hardware, platform, and operating system independent drivers, according to one embodiment of the present invention;

FIG. 2 is a block diagram illustrating a set of platform specific drivers for processing commands from platform independent drivers, according to one embodiment of the present invention;

FIG. 3 is a table describing various function calls for providing general access of hardware, according to one embodiment of the present invention;

FIG. 4 is a continuation of the table in FIG. 3 describing various function calls for providing general access of hardware, according to one embodiment of the present invention;

FIG. 5 is a table describing various function calls for providing general access of an operating system, according to one embodiment of the present invention;

FIG. 6 is a continuation of the table in FIG. 5 describing various function calls for providing general access of an operating system, according to one embodiment of the present invention;

FIG. 7 is a flow diagram illustrating a method for generating platform independent commands, according to one embodiment of the present invention; and

FIG. 8 is a flow diagram illustrating a method for processing platform independent commands with a specific platform system, according to one embodiment of the present invention.

### DETAILED DESCRIPTION OF THE FIGURES

Accordingly, at least one embodiment of the present invention provides for a method of generating generic commands. The method includes receiving a hardware command from an application to execute user control or status read-back. The method further includes translating the hardware command to a generic command. The generic command is applicable to multiple hardware and operating system. The method further includes providing the generic commands to a system component access provider, wherein the system component access provider is software capable of translating the generic commands to system specific commands. In one embodiment, multiple system component access providers are used to access different system components. For example, a hardware access provider may be used to access a specific hardware component and an operating system access provider is used to access a specific operating system.

Another embodiment of the present invention provides a method for submitting generic commands to a specific system component. The method comprises accessing the generic commands from a plurality of platform independent drivers. The generic commands are general commands applicable to multiple hardware and operating systems. The method further includes translating the commands to system specific commands capable of being processed by a specific system component. It will be appreciated that at least one advantage of the present invention is that a system may be provided which is highly transportable, allowing the same sets of drivers to be used regardless of changes to other hardware components, hardware platforms, or operating systems.

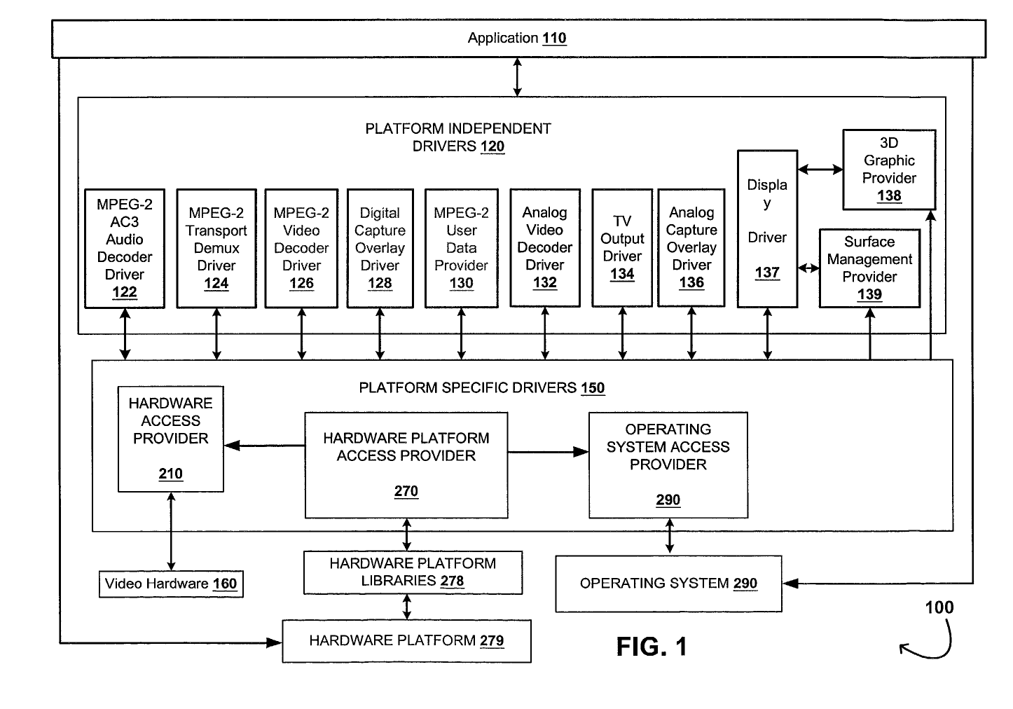

Referring now to FIG. 1, a block diagram illustrating a system for processing multimedia data through a series of platform independent drivers is shown and referenced generally as system 100, according to one embodiment of the present invention. An application 110 generates multimedia commands to be processed by hardware, such as video hardware 160 or hardware platform 279, or an operating system, such as operating system 290. The generated commands are received by a set of platform independent drivers 120. The platform independent drivers 120 convert the commands to generic commands, independent of the type of hardware or operating system present in system 100. The generic commands are received by a set of platform specific drivers 150 which use the commands to access functions of video hardware 160, hardware platform 279, or operating system 290.

In one embodiment, system 100 is used to decode data received through digital multimedia streams (not shown). Application 110 may provide processing for handling the received data. In one embodiment, a media device (not shown) such as a digital video disk (DVD) player, is connected to video hardware 160and is used to receive digital multimedia stream data, while application 110 is used to generate proper commands to access or display the multimedia related to the stream data. For example, application 110 may generate commands to video hardware 160 to access the data received through the media device. In one embodiment, the received data refers to multimedia data encoded according to the Motion Pictures Experts Group (MPEG) standard for multimedia data.

Application 110 may also issue commands for video hardware 160 to process the data received through the media device. Application 110 may also issue commands to be processed by operating system 290, or hardware platform 279. For example, application 110 may issue commands to access memory within hardware platform 279 of system 100. In prior art systems, an application program, such as application 110, generates specific commands that are translated to hardware or operating system specific commands through a series of system specific drivers. In such systems, when the hardware or operating system is replaced, the series of system specific drivers must also be replaced. To improve the portability of system 100, the present invention provides a series of platform independent drivers 120 to translate the commands from application 110 to generic commands. The generic commands generated by the platform independent drivers 120 are generic in that they are applicable to multiple hardware, hardware platforms, and operating systems.

Platform independent drivers 120, receive the commands generated by application 110. In one embodiment, platform independent drivers 120 include drivers 122-137. MPEG audio decoder 122 may be included for handling commands related to decoding digital audio data. MPEG transport demux driver 124 may be included for commands related to controlling the operations of a digital stream demultiplexer used to receive data from a digital stream. An MPEG video decoder driver 126 may be included to handle commands related to decoding digital video data. A digital capture overlay driver 128 may also be included to handle commands related to overlaying video received through a video capture port in hardware, such as video hardware 160.

An MPEG user data provider 130 may be included with platform independent drivers 120 for presenting information regarding a user of system 100, such as authentication to receive restricted multimedia channels within the digital transport stream or private and user data available in MPEG video stream. An analog video decoder driver 132 may be included for handling commands related to processing analog video data. A television (TV) output driver 134 may be included for handling commands related to processing multimedia data to be output to a TV display. An analog capture overlay driver 136 may be included for handling commands for overlaying captured analog video data.

A display driver 137 may also be included for handling commands related to presenting video data to a display associated with system 100. In one embodiment, a 3-dimensional (3D) graphics provider 138 and a surface management provider 139 are used to generate specific sets of 3D or 2-dimensional (2D) display commands for display driver 137. It will be appreciated that other drivers may be included among platform independent drivers 120. In one embodiment, platform independent drivers 120 include drivers built as dynamic link library (DLL).

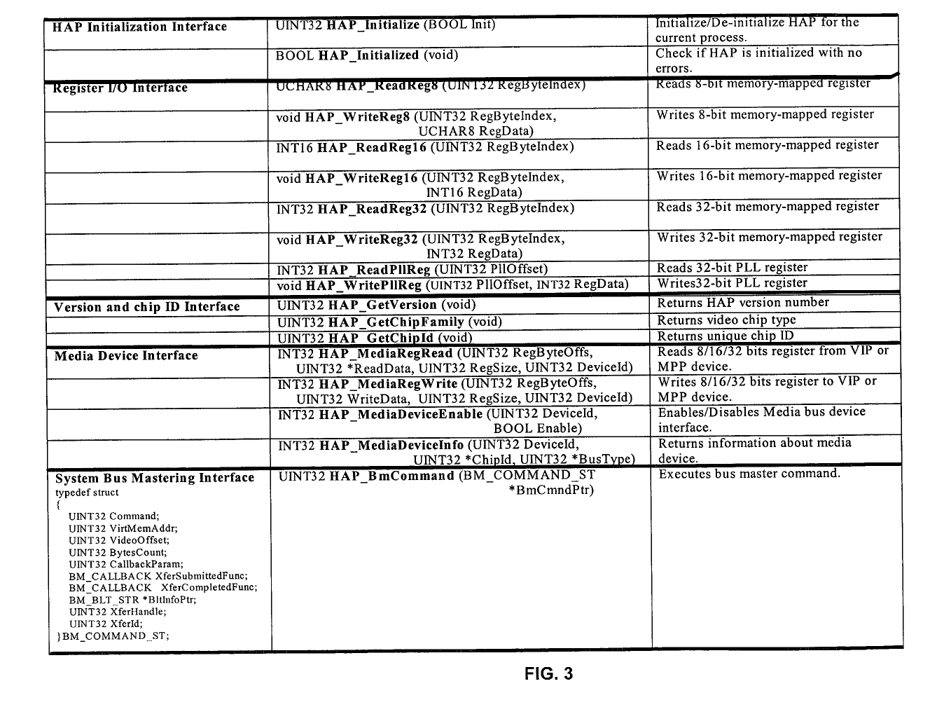

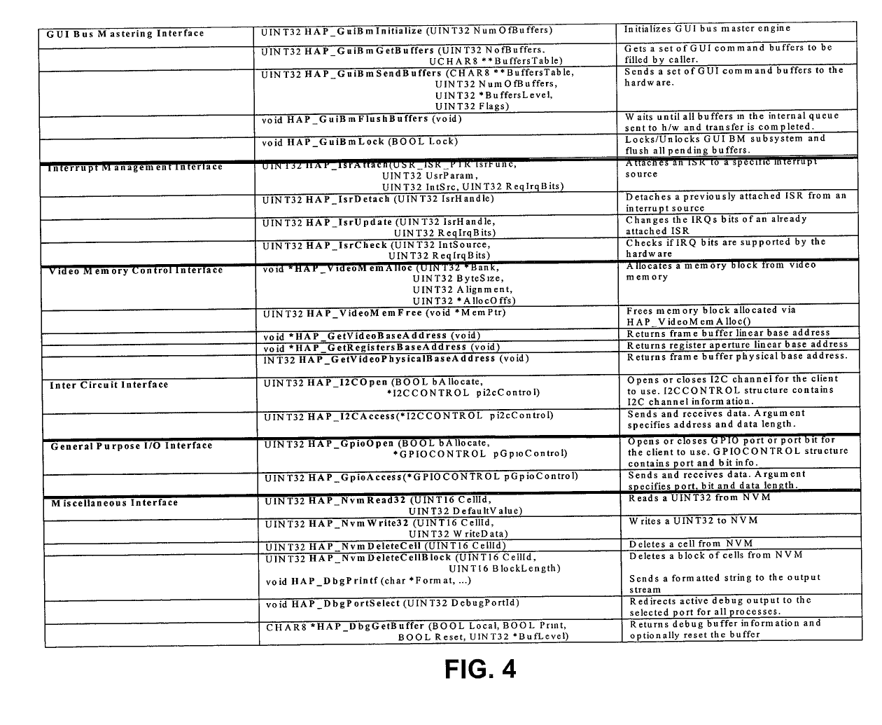

In one embodiment, platform independent drivers 120 generate function calls related to functions located in platform specific drivers 150. The platform independent drivers 120 generate the function calls by analyzing related commands generated by application 110. The functions in platform specific drivers 150 allow access to be made to video hardware 160, hardware platform 279, and operating system 290 through system specific commands. The system specific commands refer to commands that are specific to video hardware 160, hardware platform 279, or operating system 290. For example, functions located in hardware access provider (HAP) 210 generate commands to specifically access processing functions or components of video hardware 160, as are described in FIGS. 3 and 4.

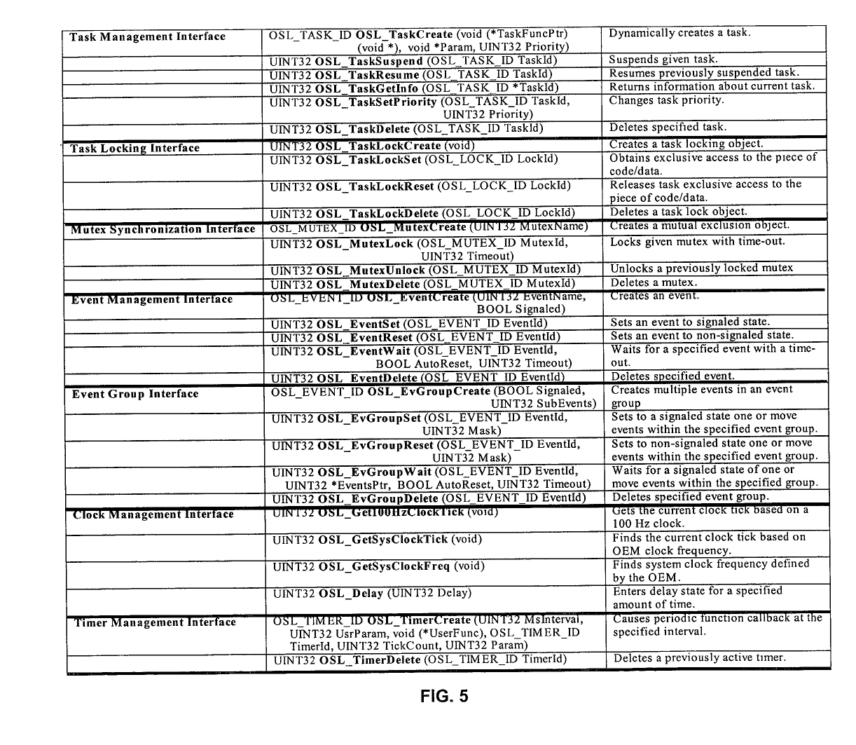

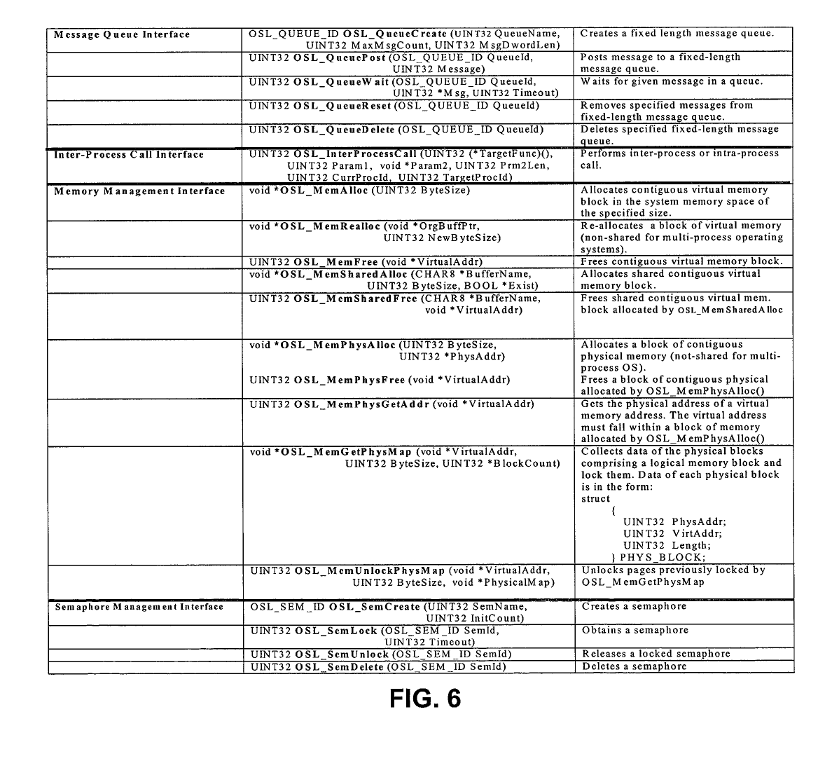

A hardware platform access provider 270 can be used to provide functions for specifically accessing components of hardware platform 279 within system 100. For example, hardware platform access provider 270 may allow access to memory (not shown) or a system bus (not shown) within system 100. In one embodiment, hardware platform access provider 270 also provides access to hardware platform libraries 278 which may be supplied with hardware platform 279. Operating system access provider 290 may include sets of functions for providing access to functional components of a specific operating system, such as operating system 290, as are described further in FIGS. 5 and 6. For example, operating system access provider 290 may provide access to have multiple processes managed by operating system 290. In one embodiment, the function calls generated by platform independent drivers 120 are protected, such as through encryption. In one embodiment, the commands between HAP 210, hardware platform access provider 270, and operating system access provider 240 and their respective components video hardware 160, hardware platform 279, and operating system 290, are sent over a system bus (not shown), such as peripheral component interconnect (PCI) bus.

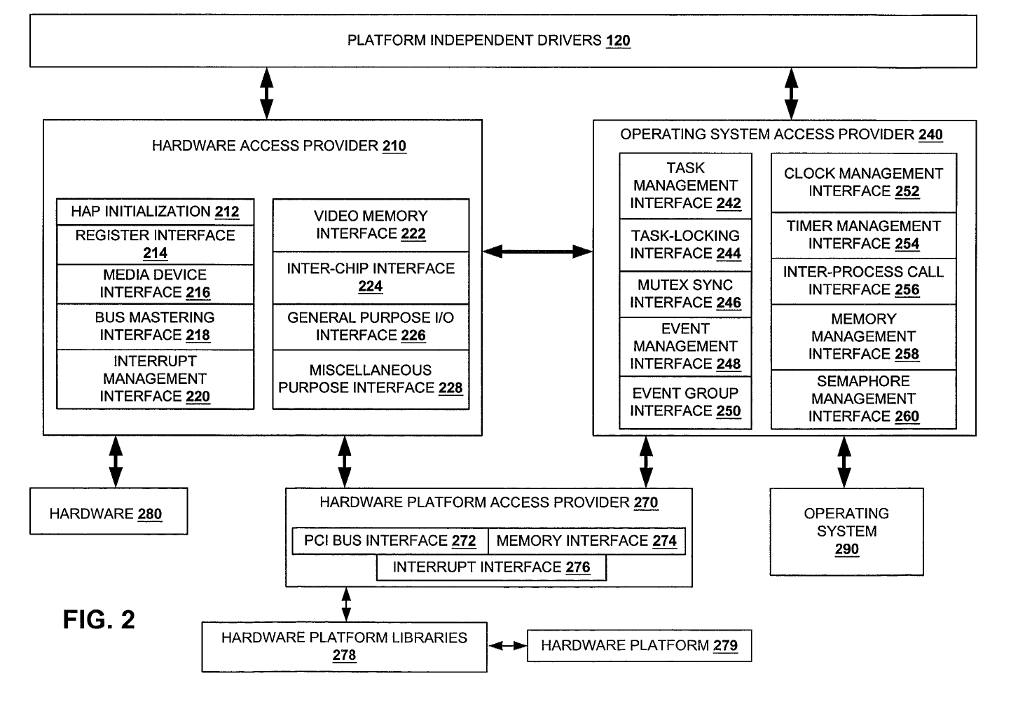

For example, application 110 may generate a command to decode a portion of video content using any available video hardware, such as video hardware 160. The command may be received through MPEG video decoder driver 126. Accordingly, MPEG video decoder driver 126 may submit a function call to hardware access provider 210 related to the video content to be processed. Hardware access provider 210 executes the function related to the submitted function call. If video data must be accessed from memory within hardware platform 279, HAP 210 may need to submit a function call to hardware platform access provider 270. HAP 210 generates a specific set of commands to video hardware 160 to process the function call generated by MPEG video decoder driver 126. Accordingly, the command generated by application 110 is effectively processed by video hardware 160, through the function calls made by platform independent drivers 120 and the functions processed through platform specific drivers 150, as is discussed further in FIG. 2.

In one embodiment, HAP 210 performs an initiation. The initiation relates to a function for communicating with video hardware 160 to determine the capabilities of video hardware 160. In one embodiment, hardware access provider is capable of providing access to a variety of hardware types and needs to ascertain which of the variety of hardware types video hardware 160 relates to. In one embodiment, hardware access provider 210 is notified about the capabilities of video hardware 160. For example, hardware access provider 210 may be informed about the abilities of video hardware 160 to handle 3D graphics processing.

In one embodiment, through the initiation, platform independent drivers 120 are provided information about the capabilities of video hardware 160, from platform specific drivers 150. For example, display driver 137 may be informed that video hardware 160 is capable of performing 3D graphics operations, allowing display driver 137 to enable commands generated through 3D graphic provider 138. In one embodiment, the function calls available to platform independent drivers 120 are initially limited and an extended set of function calls is permitted dependent on the reported capabilities of video hardware 160, hardware platform 279, or operating system 290. In one embodiment, application 110 may generate commands specific to hardware platform 279 or operating system 290. Accordingly, specific commands generated by application 110 may be ignored by platform independent drivers 120 and passed directly to hardware platform 279 or operating system 290.

If video hardware 160 is replaced with another component, only hardware access provider 210 must be replaced. If operating system 290 is changed, only operating system access provider 290 must be replaced. If system 100 is relocated using a different hardware platform, other than hardware platform 279 and hardware platform libraries 278, only hardware platform access provider 270 needs to be replaced. Accordingly, changes to the components of system 100 do not need a new set of platform independent drivers 120, making drivers 122-137 highly transportable to different system configurations.

Referring now to FIG. 2, a block diagram illustrating the platform specific drivers of FIG. 1 in more detail is shown, according to one embodiment of the present invention. Primitive drivers 120 provide generic function calls to platform specific drivers 210,240 and 270. The function calls relate to functions in the platform specific drivers 210, 240 and 270. Functional components are shown within the platform specific drivers 210, 240 and 270, representing sets of functions for accessing specific components, such as hardware 280, hardware platform 270, and operating system 290.

As previously discussed, HAP 210 provides access to a hardware component, such as hardware 280. Interfaces 212-228 represent sets of functions available through HAP 210 for accessing hardware 280. Interfaces 212-228 contain files necessary to access hardware 280. HAP 210 does not assume any specific operating system or hardware platform. HAP 210 issues commands related to an operating system or hardware platform through function calls to hardware platform access provider 270 and operating system access provider 240.

In one embodiment, HAP 210 includes a HAP initialization function 212. HAP 210 may be initialized for every driver of platform independent drivers 120 that attempt to access HAP 210. In one embodiment, before presenting commands to HAP 210 for the first time, drivers among platform independent drivers 120 submit a function call to execute HAP initialization function 212. HAP 210 may also include a register interface 214. Register interface 214 includes functions for providing access to registers within hardware 280. Access to the registers includes reading or writing register values within hardware 280. The registers may include 8-, 16-, or 32-bit registers. The registers may also include phase-locked loop (PLL) registers in hardware 280.

In one embodiment, HAP 210 includes media device interface 216. Media device interface 216 is used to access multimedia devices (not shown) attached through a port on hardware 280. The multimedia devices may include a DVD player or digital video camera. In one embodiment, the port includes a video input port (VIP). Through an initialization using HAP initialization function 212, media device interface 214 may determine the type of port used for the multimedia device. Media device interface 216 may be used to access registers in the multimedia device through 8-, 16-, or 32 bit values. A device identifier (ID) may be used in the function calls submitted to HAP 210 to identify the multimedia device to access, in the case where multiple multimedia devices are being used and are connected. In one embodiment, HAP 210 initially disables the port used to access the multimedia device. Platform independent drivers 120 submit a function call for HAP 210, to initialize the multimedia device and enable the port interfaced with the multimedia device.

In one embodiment, a bus-mastering interface 218 is included in HAP 210. Bus-mastering interface 218 provides access to a system bus, such as a PCI bus, to hardware 280. In one embodiment, bus-mastering interface 218 provides access to the system bus through a local bus specification enabling different peripherals connected to the bus to act as bus masters. By providing bus master status to hardware 280, hardware 280 is allowed to transfer data to/from system memory from/to a frame buffer in hardware 280, with minimal central processing unit (CPU) intervention. Bus-mastering interface 218 may also be used to transfer data through the multimedia device port.

In one embodiment, an interrupt management interface 220 is provided for registering, or de-registering, client interrupt service routines responsible for processing interrupts originating from various hardware cores within hardware 280. The interrupt management interface 220 may also manage interrupts and resources and report pending interrupts. Interrupt management interface 220 may also coordinate interrupt request (IRQ) usage between multiple client drivers, such as platform independent drivers 120. A video memory interface 222 may also be included to allocate frame buffer memory in hardware 280. Video memory interface 222 may be used to retrieve a linear or physical address of the frame buffer or registers in hardware 280.

In one embodiment, an inter-chip interface 224 is included to provide communications among devices connected to hardware 280 over a hardware communications interface, such as an I2C interface or a serial peripheral interface (SPI) port. A general purpose I/O interface 226 may also be included for supporting access to general-purpose I/O pins of hardware 280. General purpose I/O interface 226 may be used to set the direction of the I/O pins (tri-state settings or input/output settings) as well as reading or writing bits from/to the general-purpose I/O pins. A miscellaneous purpose interface 228 may also be provided to support miscellaneous tasks such as accessing internal memory of hardware 280, such as nonvolatile random access memory (NOVRAM) or flash memory (not shown). Miscellaneous purpose interface 228 may also support various debugging commands sent through a debugging port (not shown) of hardware 280.

Further examples of function calls and function components are described in FIGS. 3 and 4. It should be appreciated that other interface components may be provided through HAP 210 and the components described for HAP 210 are only provided to describe examples of the types of function components that may be included. Other function components may be included without departing fro the scope of the present invention.

As previously discussed, an operating system access provider 240 is used to provide access to a specific operating system, such as operating system 290. Operating system access provider 240 handles commands for processing tasks through operating system 290. In one embodiment operating system access provider 140 includes a task management interface 242. Task management interface 242 supports the creation of operating system tasks, changes in the priority assigned to specific tasks, and the deactivation of specific tasks.

A task-locking interface 244 may also be included. A task-lock serves the same purpose as a mutual exclusion (mutex) object, which allows multiple threads to access resources; however a task-lock is limited to the calling process only. A mutex synchronization interface 246 is included to provide mutex objects that may be used across processes and become signaled when abandoned by a terminating process. A mutex is a kernel object that allows any thread in a system, such as system 100 (FIG. 1) to acquire mutually exclusive ownership of a resource through operating system 290. Mutex synchronization interface 246 may include functions to create, lock, unlock, and delete mutex objects.

As described herein, a process is an inert entity characterized by its own address space. A process contains its own independent virtual address space with code and data. Each process may contain one or more independently executed threads. A thread is a unit of execution within a process that has its own stack and that is scheduled for time on the CPU by operating system 290. A process may have one or more threads executing code ‘simultaneously’, and they run within the context of an address space defined by the process (every thread sees the same data at the same address as every other thread in the same process). A process can create new threads within the process, create new, independent processes, and manage communication and synchronization between operating system objects.

In one embodiment, operating system access provider 240 also includes an event management interface 248. Event management interface 248 provides events as thread synchronization objects. Functions are provided to allow multiple threads to be released from a wait state when a single event is signaled. Event management interface 248 may include functions to create, set, reset and pulse, delete or wait on events to be signaled. An event group interface may also be included to provide groups of events that are a special implementation of multiple events. In one embodiment, operating system access provider 240 supports multiple events on a per-process basis. Multiple events are not shared among processes in multi-process operating systems.

In one embodiment, a clock management interface 252 is included to provide clocks for the platform independent drivers 120. In one embodiment, clock management 252 provides two types of clocks: a system clock and a private clock. The system clock is the clock available on hardware platform 279. As the system clock can vary according to the type of hardware platform, a fixed private clock is also provided internal to the operating system access provider 140. It should be noted that the private clock might only provide an approximate clock and an application requiring precise timing should refrain from using the private clock. A timer management interface 254 may also be included to set or delete timers. Timers are similar to interrupts that are used to call a user function periodically.

In one embodiment, an inter-process call interface 256 is also included to enable functions calling from a different process address space in a multi-process system. A memory management interface 258 may also be included to provide memory management functions suitable for various types of applications. Memory management interface 258 may assume a virtual memory management model, even if operating system 290 does not support virtual memory, to create a unified interface that can be used on various operating systems. Memory management interface 258 may include functions to allocate or free memory, such as virtual memory, physical memory, or process-shared virtual memory.

In one embodiment a semaphore management interface 160 is included in operations system access provider 240 for providing semaphores to be used by platform independent drivers 120 in mutual exclusion and task synchronization. A semaphore may represent a kernel object that has an associated numerical count. Semaphores maintain a count, and the semaphore object is signaled when the count is greater than zero. When a waiting thread is released, the semaphore count is decremented by one. Semaphore management interface 160 may include functions for creating, locking, unlocking or deleting a semaphore. It should be noted that it might be preferable to use mutexes whenever a mutual exclusion object is needed, limiting the use of semaphores to applications requiring counting objects. A description of available functions within the operating system access provider 240 is listed and described in FIGS. 5 and 6. It will be appreciated that other functions may be included without departing from the scope of the present invention.

As previously discussed, a hardware platform access provider 270 is provided for accessing hardware platform 279. Hardware access provider includes various functions that can be used to control components of hardware platform 279, such as memory or hardware interrupts. In one embodiment, hardware platform access provider 270 may include a PCI bus interface 272. The PCI bus interface 272 includes functions for accessing and managing communications between devices and components over a system bus, such as the PCI bus (not shown). A memory interface 274 may also be included to provide access to physical memory within the hardware platform 279. An interrupt interface 276 may be included to provide management of hardware interrupts. In one embodiment, hardware platform access provider 270 has access to hardware platform libraries 278. Hardware platform libraries 278 include drivers provided by a manufacturer to manage and handle components of hardware platform 279.

Access providers 210, 240 and 270 provide sets of functions for directly accessing hardware 280, operating system 290 and hardware platform 279, respectively. Platform independent drivers 120 submit function calls to have access providers 210, 240 and 270 process commands generated from applications, such as application 110 (FIG. 1).

Referring now to FIGS. 3 and 4, a table is shown describing functions to be executed through the hardware access provider, according to one embodiment of the present invention. The first (leftmost) column describes the interface components available in the HAP. The second column describes the functions available through the function components described in the first column. The third column provides a description of the process performed through the function described in the second column.

For example, a platform independent driver attempting to write a value to a 16-bit register in hardware would submit a HAP_WriteReg16 function call. As shown in FIG. 3, the function call may include an index identifying the 16-bit register being written as well as the value to write. The HAP_WriteReg16 function call would be processed through the Register I/O Interface component (Register Interface 214, FIG. 2) of the HAP. It should be appreciated that other interface components and functions may be included in the HAP, and that the functions shown in FIGS. 3 and 4 are only shown to provide an example of the types of functions that may be performed by the HAP. Other functions may be chosen without departing from the scope of the present invention.

Referring now to FIGS. 5 and 6, a table is shown illustrating functions performed through the operating system access provider, according to one embodiment of the present invention. The first (leftmost) column lists interface components available within the operating system access provider. The second column provides a list of functions that may be available through the interface component described in the first column. The third column provides a description of the processes performed through the functions from the second column.

For example, if the hardware access provider needs to suspend a given task, the hardware access provider submits an OSL_TaskSuspend function call. As shown in the second column, the OSL_TaskSuspend function call includes an identifier for the given task to be suspended. As shown in the first column, the OSL_TaskSuspend function is available through a task management interface, such as task management interface 242 (FIG. 2). It should be appreciated that functions other than those described in FIGS. 5 and 6 may be used without departing from the scope of the present invention, and the functions described through FIGS. 5 and 6 are used to only provide an example of the types of functions that may be available through the operating system access provider.

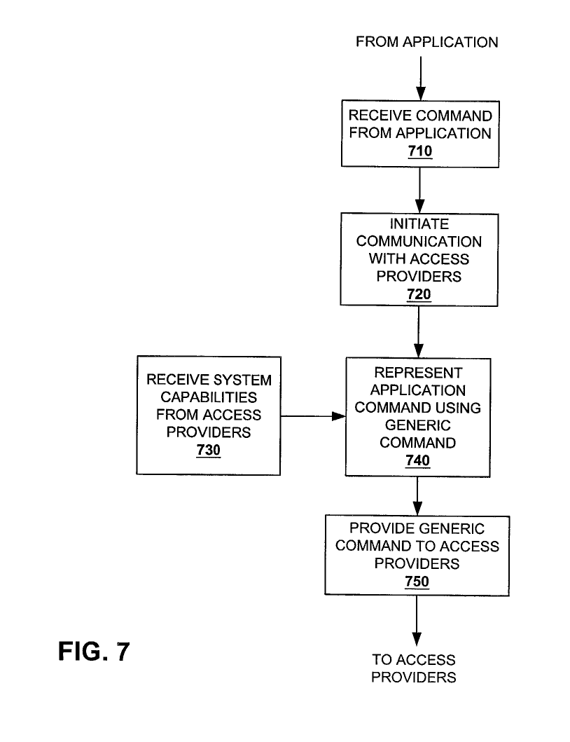

Referring now to FIG. 7, a flow diagram illustrating a method of generating commands independent of hardware or an operating system is shown, according to one embodiment of the present invention. Platform independent drivers, such as platform independent drivers 120 (FIG. 1), translate commands received from an application program to generic commands.

In step 710, the platform independent drivers receive a command from an application program. In one embodiment, the application program is related to a video-processing application program generating video data commands to be processed through video hardware. The command is received through one driver from a collection of platform independent drivers. In step 720, if the receiving platform independent driver has not communicated with an available collection of access providers, the driver sends a request to initiate communications with the access providers. In one embodiment, submitting a request to initiate communication includes submitting a function call related to an initiation function. In step 730, the driver receives information regarding system capabilities from the access providers. In one embodiment, the system capabilities include special capabilities of hardware and an operating system.

In step 740, the command received from the application program is represented using a generic command or set of generic commands. In one embodiment, a collection of function calls is available to the platform independent drivers. The driver breaks the application command into sets of function calls. The function calls represent generic commands that are applicable to a variety of hardware, platforms, and operating systems. In one embodiment, the driver uses the information received from step 730 regarding system capabilities to determine whether to expand a set of function calls available for representing the application command.

In step 750, the generic command is provided to available access providers. In one embodiment, a hardware access provider (210, FIG. 1) is used to apply the generic command to a hardware component. An operating system access provider may be used to apply the generic command to a specific operating system. A hardware platform access provider may be used to apply the generic command to components of a specific hardware component. The access providers process the generic commands through stored functions that access various features of hardware, hardware platform components, and an operating system.

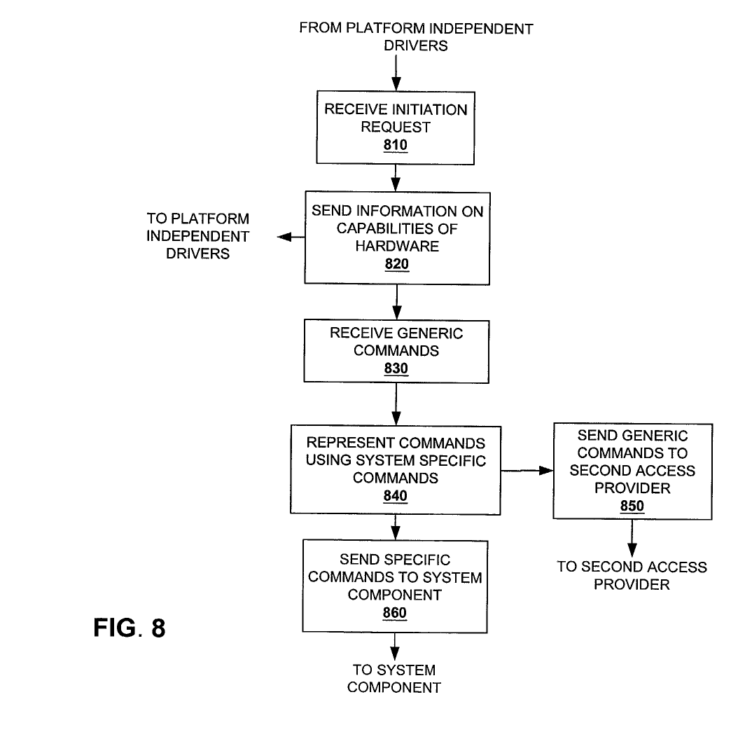

Referring now to FIG. 8, a flow diagram illustrating a method of processing generic commands is shown, according to one embodiment of the present invention. Generic commands from platform independent drivers are used to access various features of a system.

In step 810, a first access provider, from a collection of platform specific drivers, receives an initiation request from a platform independent driver. In step 820, the first access provider sends information regarding the capabilities of a related system component to the platform independent driver. As previously discussed, in one embodiment, the platform independent driver uses the sent information to expand the list of available generic commands to send to the access provider.

In step 830, the access provider receives generic commands from the platform independent driver. In one embodiment, the generic commands are represented through function calls related to specific functions of the first access provider. In step 840, the first access provider represents the generic commands using commands specific to a system component. In one embodiment, the first access provider uses a collection of functions to select commands to be sent to the specific system component. In one embodiment, different access providers are used to provide access to different system components. For example, a hardware access provider is used for selecting commands to be sent to a hardware component, an operating system access provider is used for selecting commands to be sent to a specific operating system, and a hardware platform access provider is used for selecting commands to be sent to hardware platform components.

The first access provider may determine that access to a separate system component, under the responsibility of another access provider, is necessary. For example, while the first access provider may be used for accessing a hardware component, the first access provider may need to transfer data from memory within the hardware platform to memory in the hardware component. In step 850, the first access provider sends generic commands to a second access provider to access an alternate system component. In step 860, the first access provider sends the generated system specific commands to the system component.

The systems described herein may be part of an information handling system. The term “information handling system” refers to any system that is capable of processing information or transferring information from one source to another. An information handling system may be a single device, such as a computer, a personal digital assistant (PDA), a hand held computing device, a cable set-top box, an Internet capable device, such as a cellular phone, and the like. Alternatively, an information handling system may refer to a collection of such devices. It should be appreciated that while components of the system have been describes in reference to video processing components, the present invention may be practiced using other types of system components. It should be appreciated that the system described herein has the advantage of being highly transportable, allowing a same set of drivers to be used regardless of changes to other hardware components, hardware platforms, or operating systems. While a specific method of processing platform independent commands has been described herein, it should be appreciated that other methods may be employed without departing from the scope of the present invention.

In the preceding detailed description of the embodiments, reference has been made to the accompanying drawings that form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method comprising the steps of:
receiving a hardware command from an application;
translating the hardware command to generic commands, wherein the generic commands are applicable to multiple hardware and operating systems; and
providing the generic commands to a system component access provider, wherein the system component access provider is software capable of translating the generic commands to system specific commands.

2. The method as in claim 1, wherein the method further includes the step of determining capabilities of a specific system component based upon a notification from a platform independent driver, and wherein the step of translating the hardware command to a generic command includes accounting for the capabilities of hardware.

3. The method as in claim 2, further including the step of passing system specific commands generated by the application directly to the specific system component.

4. The method as in claim 1, wherein the hardware command is related to a multimedia processing command.

5. The method as in claim 1, wherein the generic commands include function calls.

6. The method as in claim 5, wherein the function calls relate to functions in the system component access provider.

7. The method as in claim 1, wherein the system component access provider provides access to a hardware component and further wherein the system specific commands are related to the hardware component.

8. The method as in claim 7, wherein the system component access provider is further capable of providing access to a set of hardware components.

9. The method as in claim 1, wherein the system component access provider provides access to an operating system and further wherein the system specific commands are related to the operating system.

10. The method as in claim 1, wherein the system component access provider provides components of a specific hardware platform and further wherein the system specific commands are related to the specific hardware platform.

11. The method as in claim 10, wherein the system component access provider is capable of accessing a set of hardware platform libraries.

12. The method as in claim 1, wherein the application is capable of generating commands related to processing multimedia data.

13. The method as in claim 12, wherein the multimedia data is related to MPEG data.

14. The method as in claim 12, wherein the hardware command is related to processing multimedia data.

15. The method as in claim 1, wherein translating the hardware command to a generic command includes breaking the hardware command into a set of basic commands representing the functional equivalent of the hardware component and wherein the generic command represents the set of basic commands.

16. A method comprising the steps of:
accessing generic commands from a plurality of platform independent drivers, wherein the generic commands are applicable to multiple hardware and operating systems; and
translating the generic commands to system specific commands, wherein the system specific commands are capable of being processed by a specific system component.

17. The method as in claim 16, further comprising the step of providing the capabilities of the specific system component to the plurality of platform independent drivers.

18. The method as in claim 17, wherein the plurality of platform independent drivers are capable of expanding an available set of generic commands according to the reported capabilities of the specific system component.

19. The method as in claim 16, wherein the specific system component is a hardware component.

20. The method as in claim 19, wherein the hardware component includes a video processing component.

21. The method as in claim 20, wherein the video processing component is capable of processing MPEG data streams.

22. The method as in claim 16, wherein the specific system component includes an operating system.

23. The method as in claim 16, wherein the specific system component includes a specific hardware platform.

24. The method as in claim 16, wherein the generic commands relate to function calls.

25. The method as in claim 24 wherein the function calls relate to functions capable of accessing specific portions of the specific system component.

26. A system comprising:
a data processor having an I/O buffer; and
a memory having an I/O buffer coupled to the I/O buffer of the data processor; the memory capable of storing code for:
an application capable of generating system commands;
a platform independent driver capable of:
translating system commands to generic commands;
a first system component access provider capable of:
translating the generic commands to system specific commands, wherein the system specific commands are related to features of a first system component; and
a first system component capable of processing the system specific commands.

27. The method as in claim 26, wherein the first system component includes a hardware component.

28. The method as in claim 26, wherein the hardware component is a multimedia processing component.

29. The method as in claim 28, wherein the application is a multimedia processing application.

30. The method as in claim 29, wherein the application is capable of processing MPEG data.

31. The method as in claim 26, wherein the first system component includes an operating system, wherein the operating system is further capable of:
interfacing with hardware;
interfacing with memory; and
providing general data processing.

32. The method as in claim 26, wherein the first system component includes components of a specific hardware platform.

33. The method as in claim 26, wherein the system further comprises:
a second system component access provider capable of translating the generic commands to system specific commands related to a second system component; and
a second system component, different form the first system component, capable of processing the system specific commands generated by the second system component access provider.

34. The system as in claim 33, wherein the first system component access provider is capable of accessing the second system component by submitting generic commands to the second system component access provider.

35. The system as in claim 26, wherein the generic commands are applicable to multiple hardware and operating systems.

36. The method as in claim 26, wherein the generic commands include function calls.

37. The method as in claim 36, wherein the first system component access provider includes functions capable of being activated through the function calls.

38. The method as in claim 37, wherein the functions are capable of accessing portions of the first system component.

39. The method as in claim 26, wherein the generic commands are protected.

40. The method as in claim 26, wherein system commands are related specifically to the first system component are capable of being passed directly to the first system component.
